(19) United States
(12) Patent Application Publication
(10) Pub. No.: US 2007/0032382 A1
(43) Pub. Date: Feb. 8, 2007

(54) Method for enhancing the crop safety and efficacy of an agricultural chemical onto an agricultural substrate

(75) Inventors: Gregory C. Volgas, Bartlett, TN (US); Johnnie R. Roberts, Arlington, TN (US); Greg McManic, Memphis, TN (US); Mickey Brigance, Germantown, TN (US)

Correspondence Address: Connolly Bove Lodge & Hutz LLP, 1007 North Orange Street, P.O Box 2207, Wilmington, DE, 19899, US

(73) Assignee: HELENA HOLDING COMPANY, Wilmington, DE (US)

(21) Appl. No.: 11/498,583

(22) Filed: Aug. 3, 2006

Related U.S. Application Data
(60) Provisional application No. 60/705,674, filed on Aug. 4, 2005.

(51) Int. Cl. A01N 59/04; A01N 25/02; A01N 25/04

(52) U.S. Cl. 504/101; 504/362; 504/364; 504/365

(57) ABSTRACT

A method for enhancing the crop safety and efficacy of an agricultural chemical onto an agricultural substrate comprising: applying to said agricultural substrate a sufficient amount of an adjuvant composition in the form of a spray mixture, wherein said adjuvant composition comprises: an oil a surfactant capable of increasing the spreading of water a surfactant capable of increasing the spreading of oil and optionally an agrochemical.

### RELATED APPLICATIONS

This application claims benefit to Provisional Application Ser. No. 60/705,674 filed Aug. 4, 2005 which is incorporated by reference in its entirety for all useful purposes.

### BACKGROUND OF THE INVENTION

It is well known that the use of spray adjuvants can enhance the efficacy of many pesticides and particularly herbicides. Spray adjuvants have a wide array of functions which can improve spray application, enhance the efficacy of applied pesticides, or reduce off-target drift. ASTM E-1519 offers definitions of adjuvant terms and functions which both industry and academic researchers agree upon.

One such spray adjuvant consists of emulsifiable oils. Useful oils for this practice include mineral oils, vegetable oils and alkylated fatty acids.

It is known that petroleum hydrocarbon spray oils increase the efficacy of herbicides, fungicides and other pesticides by enhancing the deposition characteristics and wetting and spreading of the spray solution resulting in a more even and uniform spray deposit or by increasing the biological effect of certain pesticides. Other oils such as once-refined vegetable oils are known to exhibit similar properties. Such spray oils can increase penetration and slow evaporation. Paraffin based spray oil is a petroleum oil used as dormant spray, summer oil, carrier for pesticides or an adjuvant to increase the efficacy of agricultural chemicals.

Other adjuvants designed to enhance the efficacy of pesticides are based on emulsifiable alkylated fatty acids. More specifically, this group of adjuvants contains methylated or ethylated fatty acids derived from plant oils, such as soybean or rape seed oil. These adjuvants are commonly referred to as methylated seed oil concentrates. They are well known for their ability to improve pesticide absorption through waxy cuticles of plant surfaces, thus improving the uptake and effect of herbicides.

A drawback of these oil adjuvants is their tendency to cause or accentuate herbicide injury of desirable plants. It is generally agreed upon that if a herbicide has some tendency to cause phytotoxicity to a plant, that phytotoxicity will likely be enhanced with the addition of an adjuvant. In some cases, this phytotoxic effect can be so severe that pesticide labels warn against using oil-based spray adjuvants.

Another common spray adjuvant used to enhance herbicide efficacy is fertilizer. One example is urea-ammonium nitrate solutions (also known as UAN or URAN solutions). UAN solutions are used to enhance the herbicidal effect of sulfonyl-urea (also known as SU) herbicides. The addition of UAN solutions to pesticide sprays has been reported to improve the uptake of the pesticide into the plant. Spray deposits containing UAN often retain moisture within the deposit, and this improves absorption. Another example of a fertilizer used as an adjuvant is ammonium sulfate (AMS). AMS has been well documented to increase the efficacy of herbicides.

Surfactants have also been widely used as spray adjuvants or components of pesticide formulations. When used as spray adjuvants, surfactants can enhance the efficacy of the applied pesticide.

A specific type of surfactant which has been found useful in the invention is the polyether siloxanes. Polyether siloxanes are copolymers consisting of polymethyl siloxanes and polyether. Depending on their EO/PO ratio, the solubility of polyether siloxanes can be adjusted to obtain oil or water soluble products. Therefore polyether siloxanes are the most versatile product group among the organomodified siloxanes. These siloxane surfactants can be used to enhance the spreading of water or oil on agricultural substrates.

Emulsions are defined in the literature as either oil in water or water in oil emulsions. The term oil in this case refers to any hydrophobic non-water-soluble substance or mixture of substances. For the purposes of this invention, oil in water emulsions will be discussed. These are stable dispersions oil droplets in an aqueous medium.

A macro-emulsion contains oil droplets that are greater than 400 nm in diameter. These emulsions are characterized by a white opaque appearance due to the scattering of light by the oil droplets. Mini-emulsions contain oil droplets that are 100-400 nm in diameter. These emulsions are characterized by a hazy, translucent appearance. Micro-emulsions contain oil droplets that are 10-100 nm in diameter. The emulsions are characterized by a clear, transparent appearance. A full discussion of emulsions and definitions can be found in Rosen's Surfactants and Interfacial Phenomena, 2^{nd} edition.

In agricultural chemical formulation, it is generally recognized that formulations that form micro-emulsions are more effective at enhancing the efficacy of the active pesticide. Micro-emulsion formulations are also more phytotoxic than traditional macro-emulsion formulations.

It has well known how to produce micro-emulsions. and more particularly, how to produce micro-emulsions of methylated soybean oil. There already exist on the market today, products which contain both methylated soybean oil and UAN fertilizer. These products are actually micro-emulsions of the methylated soybean oil into the UAN fertilizer.

One such product is Dyn-A-Pak, sold by Helena Chemical Company. Dyn-A-Pak contains methylated soybean oil, UAN fertilizer, surfactants, an organosilicone surfactant designed to enhance water spreading, and an organosilicone surfactant designed to enhance oil spreading. Dyn-A-Pak has been used to enhance the efficacy of imidazilone herbicides. The product was introduced commercially in 1998 and was designed to deliver the combination of UAN fertilizer and a methylated seed oil concentrate. The methylated seed oil is emulsified into the UAN fertilizer. Specifically, it was designed to enhance the efficacy of Pursuit herbicide. Pursuit herbicide is predominantly a soybean herbicide. The market for Pursuit was severely diminished by the advent of Roundup Ready soybeans. Consequently, the market for Dyn-A-Pak was destroyed, since it was designed specifically for tank mixes with Pursuit.

### SUMMARY OF THE INVENTION

Given what is known about oils, especially, micro-emulsified oils and phytotoxicity, it would be expected that this type adjuvant would dramatically increase pesticide injury, especially in cases where the pesticide is already known to be phytotoxic to desirable foliage. Surprisingly, has been discovered that the unique combination of surfactants, nitrogen fertilizers, and micro-emulsified methylated fatty acids in Dyn-A-Pak actually decreases herbicide injury. Specifically, the use of both water and oil spreading organosilicone surfactants provide this unique combination of crop safety and herbicide enhancement. These adjuvants also enhance the desired herbicidal effect on undesirable weeds.

### EXAMPLE 1

| Ingredients | % (w/w) |
|---|---|
| UAN 32 | 58.5 |
| Water | 3.0 |
| Methylated soybean oil | 10.7 |
| AU-180 | 2.3 |
| AU-940 | 0.2 |
| Silicone defoamer | 0.1 |
| Amino ethyl ethanolamine | 0.7 |
| Blend of surfactants for emulsification | 24.5 |

In example 1, AU-180 is the organosilicone oil spreader. It is a Polyether siloxane copolymer surfactant. AU-940 is the organosilicone water spreader. It is also a polyether siloxane copolymer surfactant.

The conventional alkylated vegetable oil formulation used for comparison in field tests contain 90% by weight of methylated soybean oil and 10% nonylphenol ethoxylate.

The formulation of Example 1 has a pH of about 6.0 and is storage stable at temperatures from 4-45 degrees C. When applied to growing crops at the rate of 0.5-1.0% v/v with imidazilone herbicides using water as the carrier, the resulting weed control is superior to that of the imidazilone herbicide in water alone. Further, the injury to desirable plants is reduced in comparison with the addition of a standard alkylated vegetable oil concentrate and UAN fertilizer.

Examples of agrochemicals that can be used in the invention include but are not limited to pesticides, such as but not limited to a herbicide, an insecticide, a fungicide, a defoliant or blends thereof; a fertilizer such as but not limited to a nitrogen containing fertilizer, a phosphate containing fertilizer, a potash containing fertilizer or blends thereof.

Examples of surfactants that could be used in this formulation include but are not limited to:

Alcohol alkoxylates including but not limited to:

Based on branched and linear alcohols,

Those containing ethylene oxide or propylene oxide,

Alcohol alkoxylate sulfates,

Alkylphenol alkoxylates including but not limited to:

Nonylphenol and octylphenols.

Those containing ethylene oxide or propylene oxide

Alkanolamides,

Alkylaryl sulfonates,

Amine oxides,

Amines including but not limited to:

Fatty amine alkoxylates such as but not limited to tallowamine alkoxylates,

Betaine derivatives,

Block polymers of ethylene and propylene glycol,

Carboxylated alcohol or alkylphenol alkoxylates,

Diols, including but not limited to Butanediols,

Diphenyl sulfonate derivatives,

Ethers, including but not limited to

Butyl celluslove,

Butyl carbitol,

Ethoxylated amines,

Ethoxylated fatty acids,

Ethoxylated fatty esters and oils,

Ethoxylated triglycerides,

Fatty esters,

Glycerol esters,

Phosphate ester surfactants including but not limited to

Phosphate esters of alcohol alkoxylates,

Phosphate esters of alkylphenol alkoxylates,

Sarcosine derivatives,

Silicone-based surfactants,

Sorbitan derivatives including but not limited to:

Sorbitan esters,

Alkoxylated sorbitan esters,

Sucrose and glucose derivatives including but not limited to

Alkylpolyglucosides,

Sulfates and sulfonates of alkoxylated alkylphenols,

Sulfates of alcohols,

Tristyrylphenol Alkoxylates,

Other surfactants are disclosed in McCutcheon's Emulsifiers and Detergents, North American Edition, 2000.

Examples of oils that could be useful in this formulation include but are not limited to:

Alkylated fatty acid esters, include but are not limited to:

Methylated fatty acids, include but not limited to:

Methylated C6-C19 fatty acids,

Methylated Tall oil fatty acids,

Methylated Oleic acid,

Methylated Linoleic acid,

Methylated Linolenic acid,

Methylated Stearic acid,

Methylated Palmitic acid, and

blends thereof;

Ethylated fatty acids, include but are not limited to:

Ethylated C6-C19 fatty acids,

Ethylated Tall oil fatty acids,

Ethylated Oleic acid,

Ethylated Linoleic acid,

Ethylated Linolenic acid,

Ethylated Stearic acid,

Ethylated Palmitic acid, and

blends thereof;

Butylated fatty acids, include but are not limited to:

Butylated C6-C19 fatty acids,

Butylated Tall oil fatty acids,

Butylated Oleic acid,

Butylated Linoleic acid,

Butylated Linolenic acid,

Butylated Stearic acid,

Butylated Palmitic acid, and

blends thereof;

Alkylated natural oils, include but are not limited to:

Alkylated soybean oil, include but limited to:

Methylated soybean oil,

Ethylated soybean oil,

Butylated soybean oil, and blends thereof;

Alkylated canola oil, include but are not limited to:

Methylated canola oil,

Ethylated canola oil,

Butylated canola oil, and blends thereof;

Alkylated coconut oil, include but are not limited to:

Methylated coconut oil,

Ethylated coconut oil,

Butylated coconut oil, and blends thereof;

Alkylated sunflower oil, include but are not limited to:

Methylated sunflower oil,

Ethylated sunflower oil,

Butylated sunflower oil, and blend thereof;

Hydrocarbon oils include but are not limited to:

Mineral oils, including but are not limited to:

Paraffinic mineral oils,

Naphthenic mineral oils,

Aromatic mineral oils, and blends thereof;

Vegetable oils, include but are not limited to:

Soybean oil,

Canola oil,

Cottonseed oil, and blends thereof;

Fatty acids, include but are not limited to:

C6-C19 fatty acids,

Tall oil fatty acids,

Oleic acid,

Linoleic acid,

Linolenic acid,

Stearic acid,

Palmitic acid, and

blends thereof;

Polybutenes

Epoxified seed oils include but are not limited to:

Epoxified soybean oil and

Glycerides, including but not limited to

Glycerol

Other oils or oil substitutes.

Examples of the organosilicone surfactants useful in these formulations are polyether-polymethylsiloxane-copolymers. These polyether siloxanes are copolymers consisting of polymethyl siloxanes and polyether. Depending on their EO/PO ratio, the solubility of polyether siloxanes can be adjusted to obtain oil or water soluble products. Therefore polyether siloxanes are the most versatile product group among the organomodified siloxanes. For the purposes of this invention, it is preferred to use two separate organosilicone surfactants. One of these organo-silicone surfactant is characterized by it's ability to increase the spreading ability of water on agricultural substrates. The other of these organosilicone surfactant is characterized by it's ability to increase the spreading ability of oil droplets on agricultural substrates. For both water or oil droplets, enhanced spreading is determined by ASTM E-2044.

Preferably the formulation contains at least one surfactant selected from the group consisting of:

(a) fatty alkanolamides of the formula

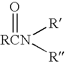

wherein R is an alkyl group having from about 6 to about 25 carbon atoms; R and R″ are the same or different and are independently selected from the group consisting of hydrogen,

—CH₂CH₂OH and

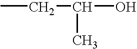

(b) PEG esters of the formula

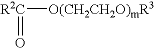

wherein R² is C₂-C₂₅ fatty alkyl having from about 2 to about 25 carbon atoms, R³ is a fatty alkyl having from about 2 to about 25 carbon atoms or hydrogen and m is a number from 1 to about 100,

(c) silicone surfactants of the formula

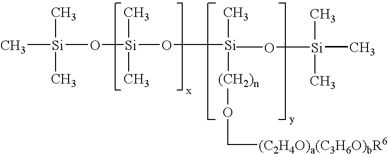

wherein x is a number from 0 to about 5, y is a number from 1 to about 5, a is a number from about 3 to about 25, b is a number from 0 to about 25, n is a number from about 2 to about 4 and R⁶ is hydrogen, an alkyl group having 1 to about 4 carbon atoms or an alkyl ester group having 1 to about 4 carbon atoms,

(d) ethoxylated fatty acids of the formula

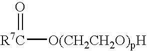

wherein R⁷ is an alkyl group having from about 6 to about 25 carbon atoms, p is a number from 1 to about 100,

(e) alkyl ethoxylates of the formula
R⁸O(CH₂CH₂O)_{q}H

wherein R⁸ is an alkyl group having from 1 to about 50 carbon atoms and q is a number from 1 to about 100,

(f) alkylphenol ethoxylates of the formula

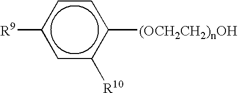

wherein R⁹ is hydrogen or an alkyl having from about 1 to about 20 carbons atoms, R¹⁰ is hydrogen or an alkyl having from about 1 to about 20 carbon atoms and n is a number from 1 to about 100;

(g) polypropylene glycols of the formula

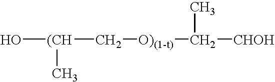

wherein t is a number from 1 to about 100,

wherein t is a number from 1 to about 100,

(h) amine ethoxylates of the formula

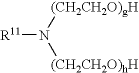

wherein g and h independently of one another are numbers from 1 to about 100 and R″ is an alkyl having from 1 to about 25 carbon atoms and

(i) tristyrylphenol alkoxylate;

optionally a buffering agent in an amount sufficient to buffer pH below about 9 and higher than 2; and

optionally a fertilizer maybe present in the amount of 1.0% to 99%.

(j) fatty alcohols

saturated or unsaturated, branch or linear C8-C20 alcohols.

(k) fatty ethers

are those generally derived from fatty alcohols characterized by the formula ROR wherein R ia an alkyl group containing from 4 to 22 carbon atoms.

(l) alkoxylated glycerides

include those derived from glycerol and C6-22 fatty acid; glycerides include glycerol mono/di-oleate.

The oil is preferably

i. vegetable oil,

ii. seed oil,

iii. paraffinic oil;

iv. fatty acids and blends thereof;

v. esterified fatty acids or blends thereof;

vi. saponified fatty acids or blends thereof;

vii. N,N-dimethylamide of the formula
RCON(CH₃)₂

wherein R is an alkyl chain derived from a fatty acid having about 6 to about 18 carbon atoms; and

viii. polybutene or

ix. glyceride, including but not limited to glycerol.

The polybutenes are preferably of the formula

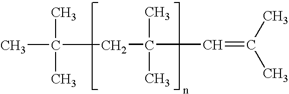

where n is a number from about 1 to about 50;

All the references described above are incorporated by reference in its entirety for all useful purposes.

While there is shown and described certain specific structures embodying the invention, it will be manifest to those skilled in the art that various modifications and rearrangements of the parts may be made without departing from the spirit and scope of the underlying inventive concept and that the same is not limited to the particular forms herein shown and described.

We claim:

1: A method for enhancing the crop safety and efficacy of an agricultural chemical onto an agricultural substrate comprising:
applying to said agricultural substrate a sufficient amount of an adjuvant composition in the form of a spray mixture, wherein said adjuvant composition comprises:
an oil
a surfactant capable of increasing the spreading of water
a surfactant capable of increasing the spreading of oil
and optionally, a fertilizer.
an agrochemical, and optionally, a fertilizer.

2. The method as described in claim 1, wherein the oil is
vegetable oil,
seed oil,
paraffinic oil;
fatty acids and blends thereof;
esterified fatty acids or blends thereof;
saponified fatty acids or blends thereof;
N,N-dimethylamide of the formula
RCON(CH₃)₂
wherein R is an alkyl chain derived from a fatty acid having about 6 to about 18 carbon atoms;
polybutene or
glyceride.

3. The method as described in claim 1, wherein the adjuvant composition contains at least one surfactant selected from the group consisting of:
fatty alkanolamides of the formula 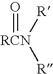
wherein R is an alkyl group having from about 6 to about 25 carbon atoms; R and R″ are the same or different and are independently selected from the group consisting of hydrogen,
—CH₂ CH₂OH and 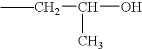
(b) PEG esters of the formula 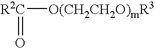
wherein R² is C₂-C₂₅ fatty alkyl having from about 2 to about 25 carbon atoms, R³ is a fatty alkyl having from about 2 to about 25 carbon atoms or hydrogen and m is a number from 1 to about 100;
(c) silicone surfactants of the formula 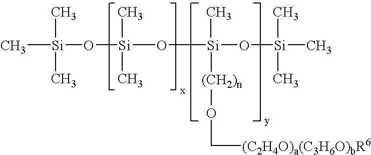
wherein x is a number from 0 to about 5, y is a number from 1 to about 5, a is a number from about 3 to about 25, b is a number from 0 to about 25, n is a number from about 2 to about 4 and R⁶ is hydrogen, an alkyl group having 1 to about 4 carbon atoms or an alkyl ester group having 1 to about 4 carbon atoms;
(d) ethoxylated fatty acids of the formula 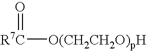
wherein R⁷ is an alkyl group having from about 6 to about 25 carbon atoms, p is a number from 1 to about 100;
(e) alkyl ethoxylates of the formula
R⁸O(CH₂CH₂O)_{q}H
wherein R⁸ is an alkyl group having from 1 to about 50 carbon atoms and q is a number from 1 to about 100;
(f) alkylphenol ethoxylates of the formula 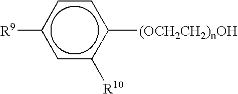
wherein R⁹ is hydrogen or an alkyl having from about 1 to about 20 carbons atoms, R¹⁰ is hydrogen or an alkyl having from about 1 to about 20 carbon atoms and n is a number from 1 to about 100;
(g) polypropylene glycols of the formula 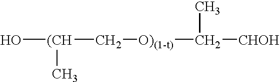
wherein t is a number from 1 to about 100;
(h) amine ethoxylates of the formula 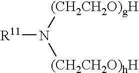
wherein g and h independently of one another are numbers from 1 to about 100 and R¹¹ is an alkyl having from 1 to about 25 carbon atoms;
(i) tristyrylphenol alkoxylate;
optionally a buffering agent in an amount sufficient to buffer pH below about 9 and higher than 2; and
optionally a fertilizer maybe present in the amount of 1.0% to 99%;
(j) fatty alcohols which are saturated or unsaturated, branch or linear C8-C20 alcohols.
(k) fatty ethers which are those generally derived from fatty alcohols characterized by the formula ROR wherein each R independently is an alkyl group containing from 4 to 22 carbon atoms and
(l) glycerides.

4. The method as described in claim 1, wherein the fertilizer is
a nitrogen containing fertilizer,
a phosphate containing fertilizer,
a potash containing fertilizer or
blends thereof.

5. The method as described in claim 1, wherein the water spreading surfactant is an organosilicone surfactant.

6. The method as described in claim 1, wherein the oil spreading surfactant is an organosilicone surfactant.

7. The method as described in claim 5, wherein the organosilicone surfactant is a polyether-polymethylsiloxane copolymer.

8. The method as described in claim 6, wherein the organosilicone surfactant is a polyether-polymethylsiloxane copolymer.

9. The method as described in claim 1, wherein the agrochemical is a pesticide.

10. The method as described in claim 9, wherein the pesticide is
a herbicide,
an insecticide,
a fungicide,
a defoliant or
blends thereof

11. A method for treating an agricultural substrate comprising:
contacting said substrate with an agrochemical composition comprising a agrochemical and a adjuvant comprising:
an oil;
a surfactant capable of increasing the spreading of water;
a surfactant capable of increasing the spreading of oil;
optionally fertilizer; and
water
by spraying said composition onto said substrate using common agrochemical practices
with the proviso that the spray mixture provides both crop safety and enhanced efficacy of the agrochemical.

12. The method as described in claim 11, wherein the oil is
vegetable oil;
seed oil;
paraffinic oil;
fatty acids and blends thereof;
esterified fatty acids or blends thereof;
saponified fatty acids or blends thereof;
N,N-dimethylamide of the formula
RCON(CH₃)₂
wherein R is an alkyl chain derived from a fatty acid having about 6 to about 18 carbon atoms;
polybutene or
glyceride.

13. The method as described in claim 11, wherein the adjuvant composition contains at least one surfactant selected from the group consisting of:
fatty alkanolamides of the formula 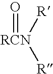
wherein R is an alkyl group having from about 6 to about 25 carbon atoms; R and R″ are the same or different and are independently selected from the group consisting of hydrogen,
—CH₂ CH₂OH and 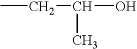
(b) PEG esters of the formula 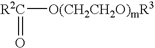
wherein R² is C₂-C₂₅ fatty alkyl having from about 2 to about 25 carbon atoms, R³ is a fatty alkyl having from about 2 to about 25 carbon atoms or hydrogen and m is a number from 1 to about 100;
(c) silicone surfactants of the formula 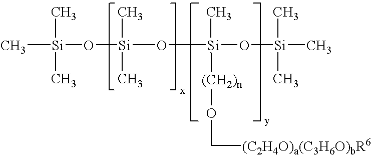
wherein x is a number from 0 to about 5, y is a number from 1 to about 5, a is a number from about 3 to about 25, b is a number from 0 to about 25, n is a number from about 2 to about 4 and R⁶ is hydrogen, an alkyl group having 1 to about 4 carbon atoms or an alkyl ester group having 1 to about 4 carbon atoms;
(d) ethoxylated fatty acids of the formula 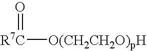
wherein R⁷ is an alkyl group having from about 6 to about 25 carbon atoms, p is a number from 1 to about 100;
(e) alkyl ethoxylates of the formula
R⁸O(CH₂CH₂O)_{q}H
wherein R⁸ is an alkyl group having from 1 to about 50 carbon atoms and q is a number from 1 to about 100;
(f) alkylphenol ethoxylates of the formula 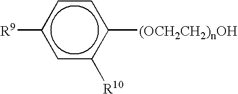
wherein R⁹ is hydrogen or an alkyl having from about 1 to about 20 carbons atoms, R¹⁰ is hydrogen or an alkyl having from about 1 to about 20 carbon atoms and n is a number from 1 to about 100;
(g) polypropylene glycols of the formula 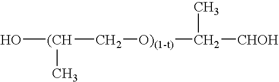
wherein t is a number from 1 to about 100;
(h) amine ethoxylates of the formula 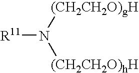
wherein g and h independently of one another are numbers from 1 to about 100 and R¹¹ is an alkyl having from 1 to about 25 carbon atoms;
(i) tristyrylphenol alkoxylate;
optionally a buffering agent in an amount sufficient to buffer pH below about 9 and higher than 2; and
optionally a fertilizer maybe present in the amount of 1.0% to 99%;
(j) fatty alcohols which are saturated or unsaturated, branch or linear C8-C20 alcohols;
(k) fatty ethers which are those generally derived from fatty alcohols characterized by the formula ROR wherein each R independently is an alkyl group containing from 4 to 22 carbon atoms and
(l) glycerides.

14. The method as described in claim 11, wherein the fertilizer is
a nitrogen containing fertilizer,
a phosphate containing fertilizer,
a potash containing fertilizer or
blends thereof.

15. The method as described in claim 11, wherein the water spreading surfactant is an organosilicone surfactant.

16. The method as described in claim 11, wherein the oil spreading surfactant is an organosilicone surfactant.

17. The method as described in claim 15, wherein the organosilicone surfactant is a polyether-polymethylsiloxane copolymer.

18. The method as described in claim 16, wherein the organosilicone surfactant is a polyether-polymethylsiloxane copolymer.

19. The method as described in claim 11, wherein the agrochemical is a pesticide.

20. The method as described in claim 19, wherein the pesticide is
a herbicide,
an insecticide,
a fungicide,
a defoliant or
blends thereof.

21. The method according to claim 1, wherein the adjuvant is present in the amount of 0.0001 to 10% by weight of said spray mixture.

22. The method according to claim 1, wherein the pH of the spray mixture is from 2 to 7.

23. The method according to claim 1, wherein a fertilizer is present in the amount of 0.0001 to 99% by weight.

24. A method for treating an agricultural substrate in the form of vegetation or soil comprising:
providing an agrochemical composition in the form of a spray mixture
containing surfactants, fertilizer, a surfactant capable of increasing the spreading of water, a surfactant capable of increasing the spreading of oil and an agrochemical, water, and at least one of a vegetable oil, modified vegetable oil, modified oil, natural oil or a paraffin oil,
applying said agrochemical composition to said substrate by spraying a sufficient amount of said composition onto said substrate by convectional agrochemical practices and
B) reducing the phytoxic response of a pesticide.

25. The method according to claim 1 wherein said spray mixture further contains a defoamer.

26. The method according to claim 1, wherein said spray mixture further contains an agent in an amount sufficient to lower the pH of the spray solution to below 7.

27. The method according to claim 11, wherein said spray mixture further contains a defoamer.

28. The method according to claim 11, wherein said spray mixture further contains an agent in an amount sufficient to lower the pH of the spray solution to below 7.

29. The method as described in claim 1 wherein the adjuvant concentrate composition comprises at least one water soluble Polyether-polymethylsiloxane-copolymer and/or oil soluble Polyether-polymethylsiloxane-copolymer, and at least one member selected from the group consisting of:
vegetable oil;
seed oil;
paraffinic oil;
fatty acids and blends thereof;
esterified fatty acids or blends thereof;
saponified fatty acids or blends thereof;
N,N-dimethylamide of the formula
RCON(CH₃)₂
wherein R is an alkyl chain derived from a fatty acid having about 6 to about 18 carbon atoms;
polybutenes of the following formula 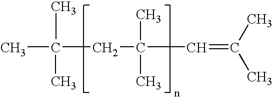
where n is a number from about 1 to about 50;
glyceride,
and/or at least one surfactant selected from the group consisting of
fatty alkanolamides of the formula 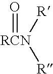
wherein R is an alkyl group having from about 6 to about 25 carbon atoms; R and R″ are the same or different and are independently selected from the group consisting of hydrogen,
—CH₂ CH₂OH and 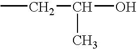
(b) PEG esters of the formula 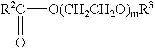
wherein R² is C₂-C₂₅ fatty alkyl having from about 2 to about 25 carbon atoms, R³ is a fatty alkyl having from about 2 to about 25 carbon atoms or hydrogen and m is a number from 1 to about 100;
(c) silicone surfactants of the formula 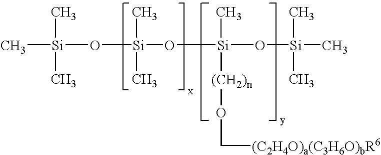
wherein x is a number from 0 to about 5, y is a number from 1 to about 5, a is a number from about 3 to about 25, b is a number from 0 to about 25, n is a number from about 2 to about 4 and R⁶ is hydrogen, an alkyl group having 1 to about 4 carbon atoms or an alkyl ester group having 1 to about 4 carbon atoms;
(d) ethoxylated fatty acids of the formula 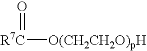
wherein R⁷ is an alkyl group having from about 6 to about 25 carbon atoms, p is a number from 1 to about 100;
(e) alkyl ethoxylates of the formula
R⁸O(CH₂CH₂O)_{q}H
wherein R⁸ is an alkyl group having from 1 to about 50 carbon atoms and q is a number from 1 to about 100;
(f) alkylphenol ethoxylates of the formula 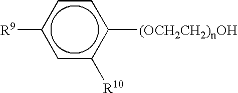
wherein R⁹ is hydrogen or an alkyl having from about 1 to about 20 carbons atoms, R¹⁰ is hydrogen or an alkyl having from about 1 to about 20 carbon atoms and n is a number from 1 to about 100;
(g) polypropylene glycols of the formula 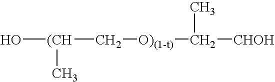
wherein t is a number from 1 to about 100;
(h) amine ethoxylates of the formula 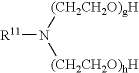
wherein g and h independently of one another are numbers from 1 to about 100 and R¹¹ is an alkyl having from 1 to about 25 carbon atoms;
(i) tristyrylphenol alkoxylate;
optionally a buffering agent in an amount sufficient to buffer pH below about 9 and higher than 2; and
optionally a fertilizer maybe present in the amount of 1.0% to 99%;
(j) fatty alcohol which is saturated or unsaturated, branch or linear C8-C20 alcohols;
(k) fatty ether which is derived from fatty alcohols characterized by the formula ROR wherein R ia an alkyl group containing from 4 to 22 carbon atoms.
(l) glyceride
and/or optionally an agent in an amount sufficient to buffer pH below 8; and optionally a fertilizer maybe present in the amount of 1.0% to 99%.

30. The method as described in claim 26, wherein the pH modifying agent is selected from the group consisting of alkylaryl polyethoxy phosphate ester, C₁-C₆ carboxylic acid, C₁-C₆ dicarboxylic acid, phosphoric acid, citric acid, glutaric acid, gluconic acid, lactic acid, glycolic acid, acrylic acid, and carboxylated alcohol ethoxylate.

31. A composition which comprises:
An oil
Surfactants
Fertilizer
An agrochemical
Optionally, a surfactant capable of increasing the spreading of water
And optionally, a surfactant capable of increasing the spreading of oil herein said composition may be added to an agriculturally acceptable diluent and applied to an agriculturally acceptable substrate.

32. The composition as described in claim 31, wherein the oil is
vegetable oil;
seed oil;
paraffinic oil;
fatty acids and blends thereof;
esterified fatty acids or blends thereof;
saponified fatty acids or blends thereof;
N,N-dimethylamide of the formula
RCON(CH₃)₂
wherein R is an alkyl chain derived from a fatty acid having about 6 to about 18 carbon atoms;
polybutene or
glyceride.

33. The composition as described in claim 31, wherein the adjuvant composition contains at least one surfactant selected from the group consisting of:
fatty alkanolamides of the formula 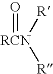
wherein R is an alkyl group having from about 6 to about 25 carbon atoms; R and R″ are the same or different and are independently selected from the group consisting of hydrogen,
—CH₂CH₂OH and 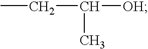
(b) PEG esters of the formula 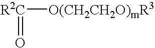
wherein R² is C₂-C₂₅ fatty alkyl having from about 2 to about 25 carbon atoms, R³ is a fatty alkyl having from about 2 to about 25 carbon atoms or hydrogen and m is a number from 1 to about 100;
(c) silicone surfactants of the formula 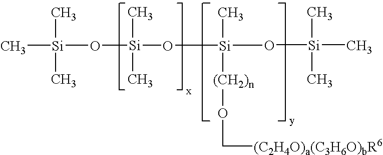
wherein x is a number from 0 to about 5, y is a number from 1 to about 5, a is a number from about 3 to about 25, b is a number from 0 to about 25, n is a number from about 2 to about 4 and R⁶ is hydrogen, an alkyl group having 1 to about 4 carbon atoms or an alkyl ester group having 1 to about 4 carbon atoms;
(d) ethoxylated fatty acids of the formula 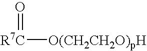
wherein R⁷ is an alkyl group having from about 6 to about 25 carbon atoms, p is a number from 1 to about 100;
(e) alkyl ethoxylates of the formula
R⁸O(CH₂CH₂O)_{q}H
wherein R⁸ is an alkyl group having from 1 to about 50 carbon atoms and q is a number from 1 to about 100;
(f) alkylphenol ethoxylates of the formula 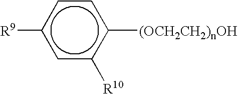
wherein R⁹ is hydrogen or an alkyl having from about 1 to about 20 carbons atoms, R¹⁰ is hydrogen or an alkyl having from about 1 to about 20 carbon atoms and n is a number from 1 to about 100;
(g) polypropylene glycols of the formula 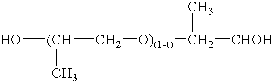
wherein t is a number from 1 to about 100;
(h) amine ethoxylates of the formula 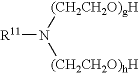
wherein g and h independently of one another are numbers from 1 to about 100 and R¹¹ is an alkyl having from 1 to about 25 carbon atoms;
(i) tristyrylphenol alkoxylate
optionally a buffering agent in an amount sufficient to buffer pH below about 9 and higher than 2; and
optionally a fertilizer maybe be present in the amount of 1.0% to 99%;
(j) fatty alcohol which is saturated or unsaturated, branch or linear C8-C20 alcohols;
(k) fatty ether which is derived from fatty alcohols characterized by the formula ROR wherein R ia an alkyl group containing from 4 to 22 carbon atoms and
(l) glyceride.

34. The composition as described in claim 31, wherein the fertilizer is selected from the group:
a nitrogen containing fertilizer;
a phosphate containing fertilizer;
a potash containing fertilizer or
blends thereof.

35. The composition as described in claim 31, wherein the water spreading surfactant is an organosilicone surfactant.

36. The composition as described in claim 31, wherein the oil spreading surfactant is an organosilicone surfactant.

37. The composition as described in claim 35, wherein the organosilicone surfactant is a polyether-polymethylsiloxane copolymer.

38. The composition as described in claim 36, wherein the organosilicone surfactant is a polyether-polymethylsiloxane copolymer.

39. The composition as described in claim 31, wherein the agrochemical is a pesticide.

40. The method as described in claim 39, wherein the pesticide is selected from the group:
Herbicide;
Insecticide;
Fungicide;
Defoliant and
blends thereof.

41. The method according to claim 1, to reduce the damage caused by an agrochemical with a balanced, storage stable, spray mixture and/or adjuvant composition that will not cause unwanted damage to a desired plant or crop.
